(19) United States
(12) Patent Application Publication
(10) Pub. No.: US 2007/0080534 A1
(43) Pub. Date: Apr. 12, 2007

(54) Rotating joint for the mutual connection of two shaft ends in particular in the drive train of a motor vehicle

(76) Inventors: Joachim Rothe, Muhldorf (DE); Josef Bauer, Isen (DE)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 10/579,699

(22) PCT Filed: Dec. 10, 2004
(86) PCT No.: PCT/EP04/14120

§ 371 Date: May 19, 2006

(30) Foreign Application Priority Data
Dec. 17, 2003 (DE) 103 59 281.4

(51) Int. Cl. F16L 33/00

(52) U.S. Cl. 285/222.1

(57) ABSTRACT

In a flexible disk (10) made of rubber-elastic material and having a central axis (A) at least two first and two second connection bodies (32, 34) are inserted alternately, with their own axis (B) parallel to the central axis (A), around the axis (A), at angular distances from one another; they are intended to be fastened each to one of the shaft ends. Flexible inserts (20) are moreover embedded in the flexible disk (10) and extend around adjacent connection bodies (32, 34). For effecting the mutual centring of the two shaft ends a centring device (40) is provided, which comprises a first and a second end plate (22, 24), which are arranged centred in relation to one another each against one end face (12, 14) of the flexible disk (10) and are pivotable about a joint centre (C) lying on the central axis (A). Independently of their subsequent fastening to the first and/or second shaft end the first connection bodies (32) are fastened to the first end plate (22)and the second connection bodies (34) to the second end plate (24) rigidly and securely against rotation.

The invention relates to a flexible coupling according to the preamble of claim 1.

Flexible couplings of this type are known from DE 2 255 533 A1 and from DE 3 942 432 C1. According to DE 2 255 533 A1, inside the flexible disk a supporting body in the form of a three-pointed star is disposed centrally relative to the reference circle of the flexible disk. Supported against the points of the star-shaped supporting body are flexible inserts in the form of sets of loops. The supporting body has a central hole that is intended to receive a centring pin, which is fastened to one of the two shaft ends connected to one another by the flexible disk. A centring that meets current requirements is not achievable with this support as, for manufacturing reasons, a predefined shape of the loop sets may be observed only with limited accuracy and is subject during operation to variations that depend i a. upon the transmitted torque. There is moreover the danger that the flexible inserts in the course of time may be damaged by the points of the star-shaped supporting body.

As a standard solution for the mutual centring of two shaft ends connected to one another by a flexible coupling of the described type, what has therefore gained acceptance is a complete separation between flexible disk and centring device, such as is known for example from DE 3 942 432 C1. There, the flexible disk merely has the task of transmitting torques and, to a certain extent, axial forces and encircles an interior, in which a separate centring device is disposed. This centring device comprises a pot-shaped end region moulded onto one of the two shaft ends, a centring bush press-fitted therein and having a vulcanized inner lining that leaves a central hole free, and a centring pin that is formed on the other shaft end and engages into said hole. However, for assembly of the flexible joint this arrangement requires an installation space that in axial direction is at least twice as wide as the flexible disk in order to allow the centring pin to be introduced into the centring bush. From DE 2 130 247 B2, however, flexible couplings are also already known, in which a connection between two shaft ends that simultaneously centres and transmits torques and axial forces is established by means of a flexible disk made of rubber-elastic material, which is partially surrounded by a pot-shaped metal body and in which further metal parts are embedded in such a way that two groups each comprising three threaded bolts as connecting bodies for connection in each case to a flange on the two associated shaft ends are prevented from moving under the effect of torques, centrifugal forces and other external forces substantially away from a predefined reference circle. The pot-shaped metal body has an end plate, which is formed by three arms arranged in a star shape, abuts an end face of the flexible disk and has three holes, which lie on the reference circle and through each of which extends one of the three threaded bolts of the first group, which are screw-connected to the flange on one of the two shaft ends. These three threaded bolts each extend through a metal insert, which is embedded in the flexible disk and supported from the inside against a cylindrical wall of the pot-shaped metal body that surrounds the flexible disk. The three threaded bolts of the second group, which are connected to a flange of the other shaft end, each extend through a recess in a star-shaped metal insert, which is likewise embedded in the flexible disk and which is supported against a central collar, which is formed on the pot-shaped metal body and engages into the central recess of the flexible disk. The serviceability of this centring device integrated in the flexible disk is dependent upon the embedded metal parts being held accurately positioned relative to one another during vulcanizing of the flexible disk, this being complex. The use of such metal parts is moreover incompatible with the flexible inserts, which are typical of a flexible joint of the initially described type to be developed by the invention and which are embedded in the flexible disk and extend in the manner of thread loops around adjacent connection bodies.

The underlying object of the invention is to fashion a flexible coupling of the initially described type in such a way that it is easy to manufacture, little installation space, particularly in axial direction, is required for its assembly and high standards of the accuracy of the centring of the two mutually connected shaft ends are met.

The object is achieved according to the invention by the features of claim 1.

By virtue of the fact that according to the invention two end plates are provided disposed one on each end face of the flexible disk, that said end plates are centred flexibly in relation to one another, and that all of the connection bodies, whether they are bushes or threaded bolts, are rigidly fastened in each case to one of the two end plates, all of the connection bodies, and hence the associated shaft ends too, remain centred in relation to one another in all operating states of the flexible coupling according to the invention. The fact, that the fastening of each of the connection bodies to its associated end plate is from the outset also secure against rotation, rules out the danger, which exists with known flexible couplings of the initially described type, that during fitting of the flexible coupling to the shaft ends to be connected thereby unwanted tension differences in the flexible inserts may arise, which might alter the operating characteristics of the flexible disk and shorten its service life.

Advantageous developments of the invention arise from the sub-claims.

Embodiments with further details of the invention are described below with reference to schematic drawings. The drawings show:

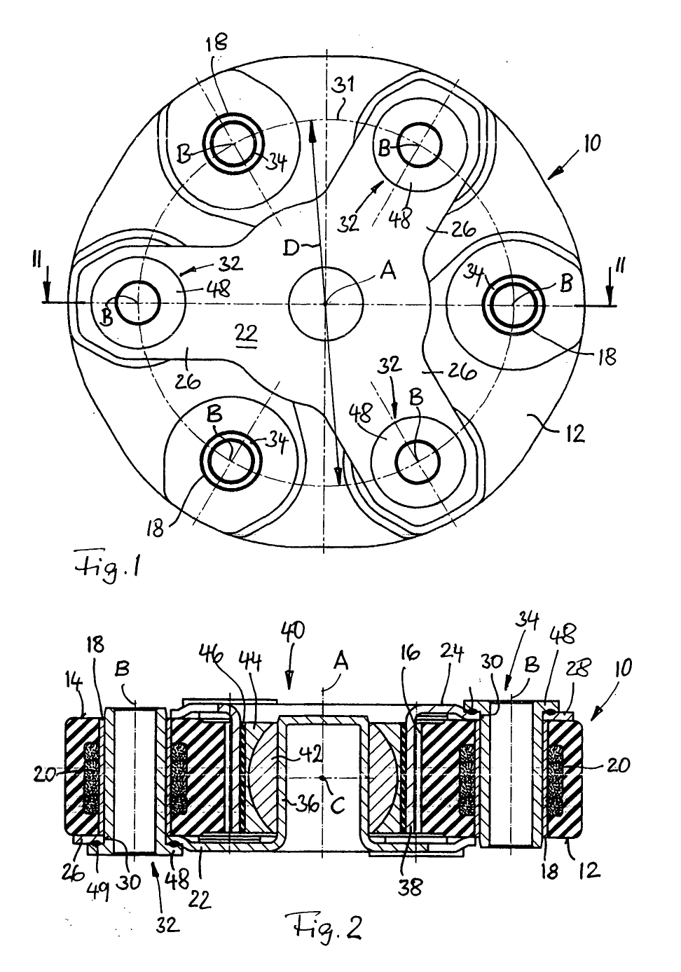

FIG. 1 a front view of a first flexible coupling according to the invention and

FIG. 2 the section II-II in FIG. 1;

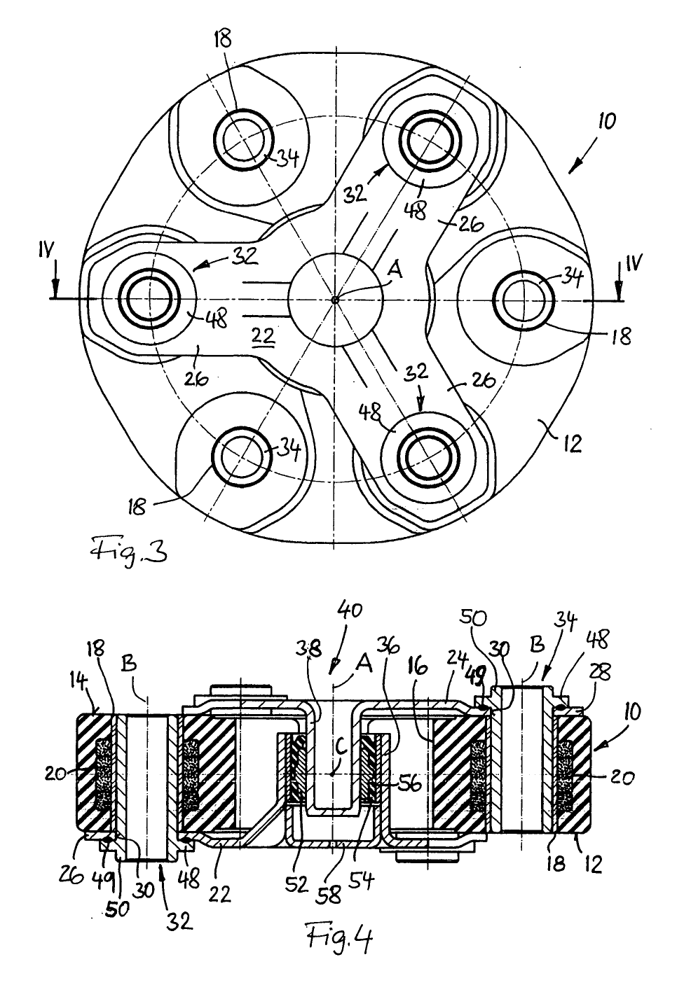

FIG. 3 a front view of a second flexible coupling according to the invention and

FIG. 4 the section IV-IV in FIG. 3;

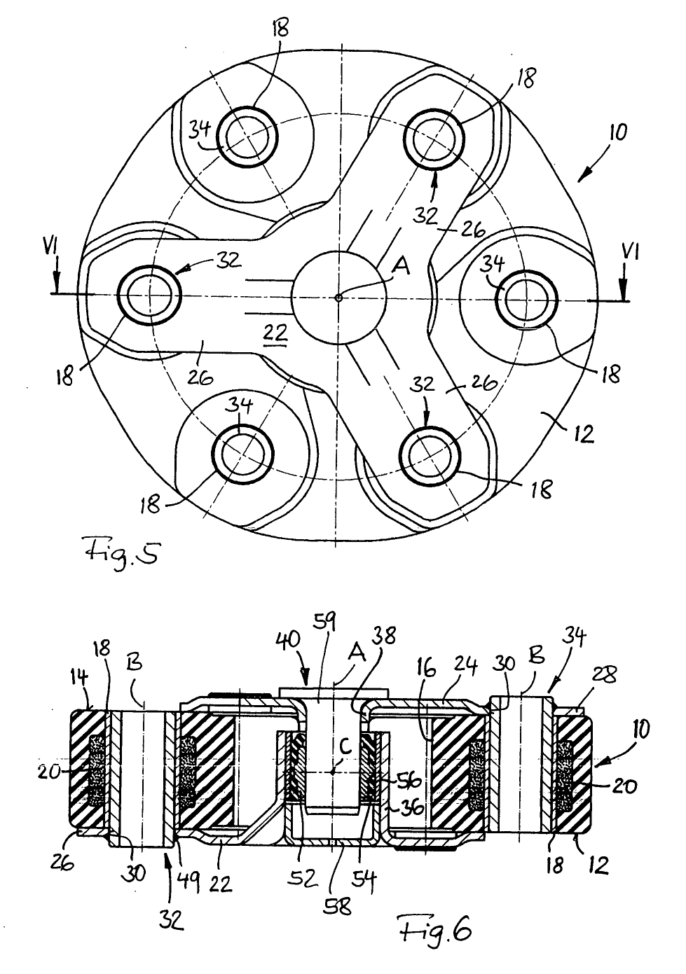

FIG. 5 a front view of a third flexible coupling according to the invention and

FIG. 6 the section VI-VI in FIG. 5;

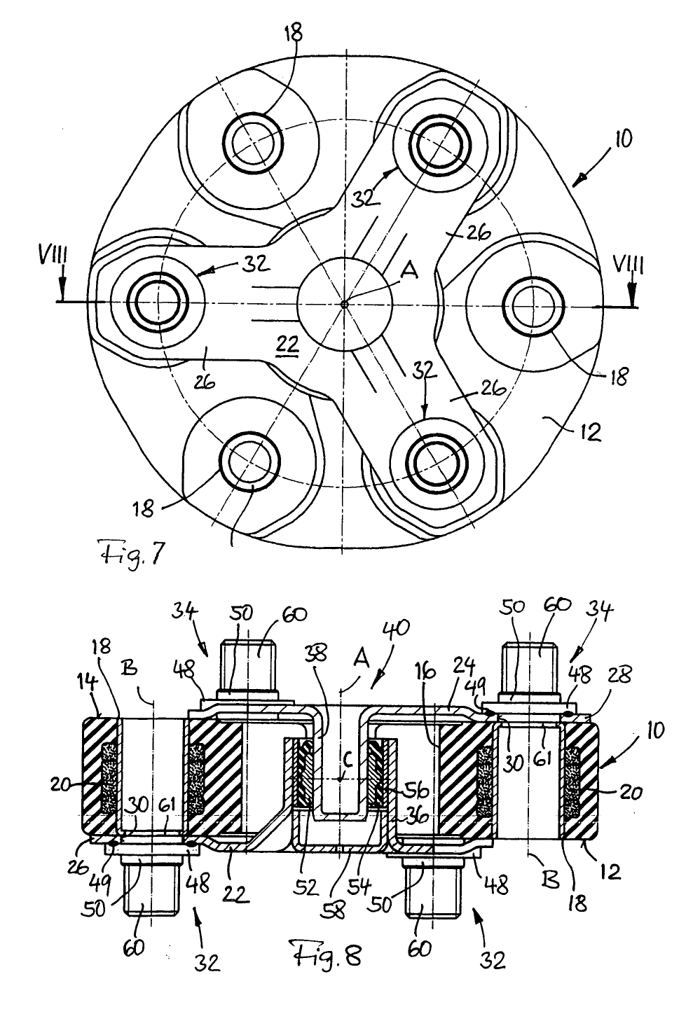

FIG. 7 a front view of a fourth flexible coupling according to the invention and

FIG. 8 the section VIII-VIII in FIG. 7;

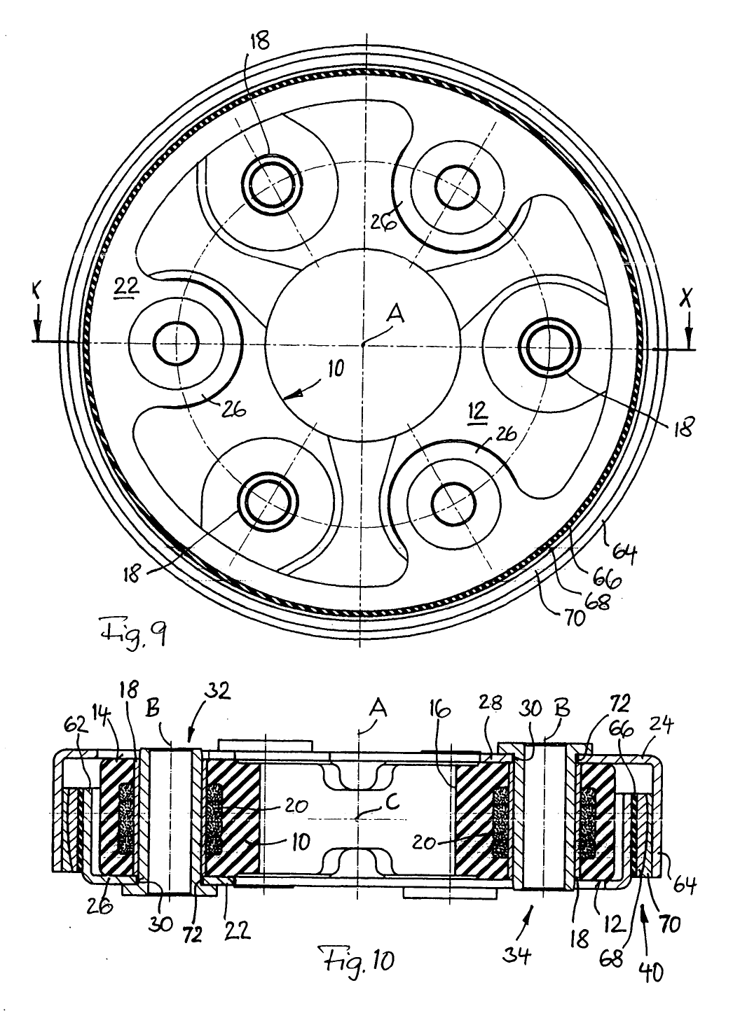

FIG. 9 a front view of a fifth flexible coupling according to the invention and

FIG. 10 the section X-X in FIG. 9.

The flexible coupling illustrated in FIGS. 1 and 2 has, as a basic torque-transmitting component, a flexible disk 10 made substantially of rubber or some other rubber-like elastic material, which is fashioned substantially rotationally symmetrically in relation to a central axis A, is delimited by two substantially flat end faces normal to the axis, namely a first end face 12 and a second end face 14, and has a circular central recess 16. Vulcanized into the flexible disk 10 are six circular-cylindrical sleeves 18, the axes B of which are disposed parallel to the central axis A on a common reference circle at uniform angular intervals of 60°. Around each of the sleeves 18 together with each of the sleeves 18 adjacent thereto are wrapped flexible inserts 20 in the form of thread loops, which are likewise vulcanized into the material of the flexible disk 10. To this extent, the flexible disk 10 is of a conventional design.

The flexible disk 10 is disposed between two end plates stamped from sheet steel, namely a first end plate 22 and a second end plate 24, each of which has three arms 26 and/or 28 projecting radially away from a flat central region. The arms 26 and 28 are cranked in the direction of the flexible disk 10 and lie in each case against an end face 12 and/or 14 thereof. Each of the arms 26 and 28 has a circular hole 30 and these holes 30 at any rate after assembly of the flexible coupling, as illustrated, lie on a common reference circle 31 with the sleeves 18. The holes 30 in the arms 26 of the first end plate 22 are aligned with every second sleeve 18, and the second end plate 24 is rotated through 60°relative to the first end plate 22, so that the holes 30 in its arms 28 are each aligned with one of the three remaining sleeves 18.

Into each of the three holes 30 of the first end plate 22 and into each of the sleeves 18 aligned with these holes a first connection body 32 is inserted, preferably press-fitted with an interference fit. In a corresponding manner, into each of the three holes 30 of the second end plate 24 and into each of the sleeves 18 aligned therewith a second connection body 34 is inserted, preferably press-fitted with an interference fit. Already by these means the two end plates 22 and 24 are held together with the flexible disk 10. In addition, the two end plates 22 and 24 each have a cylindrical central collar 36 and/or 38, which according to FIG. 2 projects into the central recess 16 of the flexible disk 10 without directly touching the flexible disk. The two collars 36 and 38 are component parts of a centring device 40, by means of which the two end plates 22 and 24 are held centred in relation to one another and connected to one another pivotably about a joint centre C lying on the central axis A.

According to FIG. 2, the first collar 36 formed on the first end plate 22 has a much smaller diameter than the second collar 38 formed on the second end plate 24. The two collars 36 and 38 therefore delimit an annular space, in which according to FIG. 2 an inner flexible body 42 with a convex spherical outer surface and a cylindrical inner surface as well as an outer flexible body 44 with a concave spherical inner surface and a cylindrical outer surface are disposed in such a way that the two spherical surfaces are in mutual abutment. The inner flexible body 42 is slipped, preferably pressed with an interference fit, by its cylindrical inner surface onto the first collar 36; the outer flexible body 44 is embedded, preferably vulcanized, by its cylindrical outer surface via an intermediate layer 46 of rubber or some other elastomer in the second collar 38.

The arrangement described thus far is additionally stabilized by rigidly fastening each of the connection bodies 32 and 34 to the end plate 22 and/or 24 associated therewith. In the case of the flexible coupling illustrated in FIGS. 1 and 2, this rigid fastening is brought about by each of the connection bodies 32 and 34 having a flange 48, which rests on and is welded to the associated arm 26 and/or 28 of the relevant end plate 22 and/or 24. Preferably, on each flange 48 a plurality of weld points 49 are provided, which are mutually offset at approximately uniform angular distances around the relevant axis B. The—in the assembled state of the flexible coupling—common reference circle 31 of the holes in the arms 26 and 28 of the end plates 22 and 24 has a diameter D, with which the reference diameter of the sleeves 18—or, in more general terms, holes—in the flexible disk 18 need not from the outset be identical. It may be advantageous when the flexible disk 10 as such has a reference diameter that is greater than D. In this case, the flexible disk 10 has to be radially compressed, for example by means of a tightening strap looped around its outer lateral surface, before the connection bodies 32 and 34, which have already been inserted in and preferably welded to their end plate 22 and 24 respectively, are press-fitted into the flexible disk 18. Radial compression produces in the flexible disk 10 a bias that has an—in certain applications—desired influence on the torque-turning angle characteristic of the flexible disk. The term “smooth zero passage” is used for the changeover from traction operation to coasting of the drive train equipped with such a biased flexible disk 10. The characteristic curve of the flexible disk 10 remains substantially constant throughout its life, even if the flexible disk is disassembled each time repairs are carried out on the drive train. The end plates 22 and 24 namely ensure, in combination with the connection bodies 32 and 34, that the radial bias is maintained in the flexible disk 10.

The flexible coupling according to FIGS. 3 and 4 differs from the one illustrated in FIGS. 1 and 2 in that each of the connection bodies 32 and 34 has, projecting beyond its flange 48, a cylindrical projection 50 that is intended to engage with a tight fit into a bore of a flange or the like on the associated, non-illustrated shaft end. The necessary tight-fitting connection to each of the two shaft ends that are to be connected to one another by the flexible coupling may however alternatively be established by using fitting bolts to fasten the connection bodies 32 to one of the two shaft ends and the connection bodies 34 to the other shaft end. This applies equally to the forms of construction according to FIGS. 1 and 2, according to

FIGS. 3 and 4, according to FIGS. 5 and 6 and according to FIGS. 9 and 10, where the connection bodies 32 and 34 are in each case cylindrical bushes.

A further difference of the flexible coupling according to FIGS. 3 and 4 from the one illustrated in FIGS. 1 and 2 lies in the design of the centring device 40, in which according to FIG. 4 the central collar 38 formed on the second end plate 44 has a smaller diameter and is encircled by the collar formed on the first end plate 22. Disposed in the annular space between these two collars 36 and 38 are an inner flexible body 52 that is slipped, preferably pressed with an interference fit, onto the collar 38 and has a vaguely T-shaped bead profile, an elastomer body 54 that surrounds this profile, and a bearing sleeve 56 that is press-fitted into the first collar 36. The elastomer body 54 is preferably a rubber body vulcanized onto the outside of the inner flexible body 52 and onto the inside of the bearing sleeve 56. The second collar 38 according to FIG. 4, thus far comparable to the first collar 36 in FIG. 2, has a closed end and is therefore stiffened. According to FIG. 4, the centring device 40 is extensively protected against dirt penetration; in addition to the configuration of the end plates 22 and 24, this is realized by means of a cap 58 that is press-fitted into the first collar 36.

The flexible coupling according to FIGS. 5 and 6 differs from the one illustrated in FIGS. 3 and 4 in that the connection bodies 32 and 34 are formed by flange-free pipe pieces that are welded directly to the associated arm 26 and/or 28 of the first end plate 22 and/or second end plate 24. Furthermore, according to FIG. 6 the second collar 38 formed on the second end plate 24 is much shorter, and its fixed connection to the inner flexible body 52 is established by means of a centring pin 59 that is press-fitted into the inner flexible body 52 and into the collar 38.

The flexible coupling according to FIGS. 7 and 8 corresponds to the one illustrated in FIGS. 3 and 4 except that the connection bodies 32 and 34 are not tubular but take the form of solid bolts each having a threaded pin 60 that projects beyond its cylindrical projection and is intended to extend through a flange of the associated first and/or second shaft end and be fastened at the rear of said flange by means of a nut. A further characteristic feature of the form of construction illustrated in FIGS. 7 and 8 is that each of the connection bodies 32 and 34 has, at a distance from its flange 48 that corresponds to the sheet thickness of the associated arm 26 and/or 28, an annular groove 61, into which an end region of the associated sleeve 18 engages. This engagement comes about because the sleeve 18 was originally slightly longer and projected beyond the relevant end face 12 and/or 14 of the flexible disk 10 and, in the course of the connection body 32 and/or 34 being press-fitted through the associated hole 30 into the relevant sleeve 18, was bent radially inwards.

The flexible coupling according to FIGS. 9 and 10 corresponds to the one illustrated in FIGS. 1 and 2 except that the centring device 40 is not accommodated in the central recess 16 of the flexible disk 10 but disposed radially outside of the flexible disk 10. In this case too, however, the centring device 40 comprises a first collar 62, which is formed at a radial distance from the lateral surface of the flexible disk 10 on the first end plate 22, and a second collar 64 formed on the second end plate 24, which collars together delimit an annular space. This annular space contains, vulcanized by means of an intermediate layer 66 of rubber or some other elastomer to the first collar 62, an annular inner flexible body 68 with a convex spherical outer surface as well as a likewise annular outer flexible body 70, which is press-fitted into the second collar 64 and has a concave spherical inner surface that directly abuts the convex spherical outer surface of the inner flexible body 68. With this design of the centring device 40 too, its joint centre C lies on the central axis A midway between the two end faces 12 and 14 of the flexible disk 10.

A further difference of the flexible coupling according to FIGS. 9 and 10 from the flexible couplings illustrated in the preceding drawings is that the rigid fastening of the connection bodies 32 and 34 to the associated end plate 22 and 24 respectively is produced not by welding but in that a region of the outer surface of the relevant connection body adjoining the flange 48 is provided with an anchoring profile 72, for example a serration profile, which is press-fitted into the hole 30 of the relevant end plate 22 and/or 24 in such a way that the connection bodies are fastened securely against rotation and preferably also in an axially non-displaceable manner to the relevant end plate.

1. Flexible coupling for mutually connecting two shaft ends, in particular in the drive train of a motor vehicle, having
a flexible disk (10) made of rubber-elastic material, which has a central axis (A),
at least two first and two second connection bodies (32, 34), which are inserted alternately, with their own axis (B) parallel to the central axis (A), around the axis (A), at angular distances from one another into the flexible disk (10) and are intended to be fastened each to one of the shaft ends, flexible inserts (20), which are embedded in the flexible disk (10) and extend around adjacent connection bodies (32, 34), and
a centering device (40) for mutually centering the two shaft ends, characterized in that
the centering device (40) comprises a first and a second plate (22, 24), which are arranged centered in relation to one another each against one end face (12, 14) of the flexible disk (10) and are pivotable about a joint centre (C) lying on the central axis (A), and
independently of their subsequent fastening to the first and/or second shaft end the first connection bodies (32) are fastened to the first end plate (22) and the second connection bodies (34) to the second end plate (24) rigidly and securely against rotation.

2. Flexible coupling according to claim 1,
characterized in that the two end plates (22, 24) each have a collar (36, 38) engaging into the flexible disk (10) and are centered in relation to one another by means of said collars.

3. Flexible coupling according to claim 1,
characterized in that the two end plates (22, 24) each have a collar (62, 64) embracing the flexible disk (10) radially at the outside and are centered in relation to one another by means of said collars.

4. Flexible coupling according to claim 2,
characterized in that the two end plates (22, 24) are held by means of their collars (36, 38, 62, 64) in axial abutment with the flexible disk (10).

5. Flexible coupling according to claim 1,
characterized in that the connection bodies (32, 34), at the edge of a hole (30) of the associated end plate (22, 24) that receives them, are welded to said end plate.

6. Flexible coupling according to claim 1,
characterized in that the connection bodies (32, 34) in each case by means of an anchoring profile (72) formed thereon are anchored securely against rotation on the associated end plate (22, 24).

7. Flexible coupling according to claim 1,
characterized in that the connection bodies (32, 34) are inserted in each case into a sleeve (18), which is associated with and embedded in the flexible disk (10) and around which at least one of the flexible inserts (20) is looped.

8. Flexible coupling according to claim 7,
Characterized in that the sleeve (18) is connected to the associated connection body (32, 34) such as to transmit tensile forces in the direction of the axis (B) of said connection body and the associated end plate (22, 24) is therefore held in abutment with the flexible disk (10).

9. Flexible coupling according to claim 1,
characterized in that the connection bodies (32, 34) each have a flange (48) for effecting fastening to the associated end plate (22, 24).

10. Flexible coupling according to claim 1,
characterized in that the connection bodies (32, 34) each have a projection (50) for effecting centering on the associated shaft end.

11. Flexible coupling according to claim 1,
characterized in that the flexible disk (10) is held under radial bias by the end plates (22, 24) in combination with the connection bodies (32, 34).
